(19) United States
(12) Patent Application Publication
(10) Pub. No.: US 2026/0229574 A1
(43) Pub. Date: Aug. 6, 2026

(54) ELECTRODE ASSEMBLY ALIGNMENT DEVICE AND ELECTRODE ASSEMBLY ALIGNMENT METHOD

(71) Applicant: SK ON CO., LTD., Seoul (KR)

(72) Inventors: You-Been HA, Daejeon (KR); Jung-Hwan LIM, Daejeon (KR)

(21) Appl. No.: 19/142,223

(22) PCT Filed: Jan. 4, 2024
(86) PCT No.: PCT/KR2024/000163

§ 371 Date: Jun. 23, 2025

(30) Foreign Application Priority Data
Jan. 27, 2023 (KR) 10-2023-0011138
Dec. 13, 2023 (KR) 10-2023-0181050

(51) Int. Cl. H01M 10/04; H01M 50/105; H01M 50/178; H01M 50/186

(52) U.S. Cl. CPC H01M 10/0404; H01M 10/0468; H01M 50/178; H01M 50/186; H01M 50/105

(57) ABSTRACT

An electrode assembly alignment device of the present disclosure may comprise: a carrier for supporting an electrode assembly; a lifting unit including at least one pressing unit for spacing the electrode assembly apart from the carrier; a sensor unit for detecting the location of the electrode assembly; and an alignment unit connected to the lifting unit, and configured to move based on the position of the electrode assembly detected by the sensor unit. The alignment unit can move relative to the carrier together with the electrode assembly and the lifting unit when the electrode assembly is spaced apart from the carrier.

This application is a national stage application of PCT/KR2024/000163 filed on Jan. 4, 2024, which claims priority to Korean Patent Application No. 10-2023-0011138 filed on Jan. 27, 2023, and Korean Patent Application No. 10-2023-0181050 filed on Dec. 13, 2023. The disclosure of each of the foregoing applications is incorporated herein by reference in its entirety.

### TECHNICAL FIELD

The present disclosure relates to an electrode assembly alignment device and an electrode assembly alignment method.

### BACKGROUND ART

Unlike a primary battery, a secondary battery may be charged with and discharged of electricity, so the secondary battery may be applied to devices within various fields such as digital cameras, mobile phones, laptops, hybrid cars, electric cars, and energy storage systems (ESS). A secondary battery may include a nickel-cadmium battery, a nickel-metal hydride battery, a nickel-hydrogen battery, a lithium secondary battery, or the like.

A secondary battery is manufactured as flexible pouch-type battery cells or rigid square or cylindrical can-type battery cells. A plurality of battery cells may be formed into a cell assembly in a stacked form. Each of the plurality of battery cells may include an electrode assembly.

The cell assembly may be disposed inside the case to form a battery module, and a plurality of battery modules may be disposed inside the pack housing to form a battery pack. The battery pack may be used in various structures such as a vehicle or an energy storage system.

### DISCLOSURE OF INVENTION

### Technical Problem

A battery cell may include an electrode assembly. For a process of manufacturing the battery cell (e.g., a process of sealing an electrode tab and a pouch), a task of aligning a position and posture of the electrode assembly may be required.

For example, an electrode assembly may be aligned by using a guide block contacting a side surface (e.g., a long side or a short side) of the electrode assembly. However, when the side surface of the electrode assembly contacts the guide block, the electrode assembly may be damaged, such as by a separator being pressed. In addition, a degree of alignment precision may be reduced due to friction between the electrode assembly and a carrier.

According to an aspect of the present disclosure, an electrode assembly alignment device and an electrode assembly alignment method that can align an electrode assembly without contacting a side surface of the electrode assembly may be provided. Since the side surface of the electrode assembly is not in contact with the electrode assembly alignment device, damage to the electrode assembly (e.g., wrinkles in a separator and damage to an electrode plate) may be prevented.

According to an aspect of the present disclosure, alignment accuracy of an electrode assembly may be improved by quantitatively detecting a position of the electrode assembly using a sensor unit. By improving the alignment accuracy of the electrode assembly, a production yield of battery cells can be improved.

An electrode assembly manufactured using the electrode assembly alignment device and the electrode assembly alignment method of the present disclosure may be widely applied to devices in green technology fields such as electric vehicles, battery charging stations, and other solar and wind power generation using batteries. In addition, the electrode assembly manufactured using the electrode assembly alignment device and the electrode assembly alignment method of the present disclosure may be used in eco-friendly electric vehicles, hybrid vehicles, etc., to prevent climate change by suppressing air pollution and greenhouse gas emissions.

### Solution to Problem

According to an aspect of the present disclosure, an electrode assembly alignment device includes a carrier configured to support an electrode assembly; a lifting unit including at least one pressing unit configured to separate the electrode assembly from the carrier; a sensor unit configured to detect a position of the electrode assembly; and an alignment unit connected to the lifting unit, and configured to move based on the position of the electrode assembly detected by the sensor unit. The alignment unit may be configured to move relatively to the carrier together with the at least one pressing unit supporting the electrode assembly while the electrode assembly is spaced apart from the carrier.

In an embodiment, the lifting unit may include a cylinder connected to the at least one pressing unit and a support plate connected to the cylinder. The cylinder may move in a first direction from the support plate toward the carrier.

In an embodiment, the alignment unit may be configured to move linearly in a second direction, perpendicular to the first direction, together with the support plate, or rotate around an axis disposed in the first direction.

In an embodiment, the carrier may include at least one recess providing a path through which the lifting unit passes.

In an embodiment, a cross-sectional area of the at least one recess may be greater than a cross-sectional area of the at least one pressing unit.

In an embodiment, the electrode assembly alignment device may further include a processor configured to determine a position of the electrode assembly, based on the position information detected by the sensor unit, and generate a signal for linearly moving or rotating the alignment unit.

In an embodiment, the electrode assembly alignment device may further include a memory configured to t store reference position information of the electrode assembly. The processor may generate a signal for linearly moving or rotating the alignment unit based on a difference between the reference position information and positions of the electrode assembly and the carrier detected by the sensor unit.

In an embodiment, the sensor unit may include at least one of a vision camera or a distance sensor configured to detect a position of an edge of the electrode assembly or a position of an electrode tab connected to the electrode assembly.

In an embodiment, the electrode assembly may include an upper surface, a rear surface opposite to the upper surface, and a side surface surrounding at least a portion between the upper surface and the rear surface. The at least one pressing unit may be in contact with the upper surface or the rear surface.

According to an aspect of the present disclosure, an electrode assembly alignment method includes a carrier moving process of moving a carrier on which an electrode assembly is mounted; a sensing process of detecting a position of at least one of the electrode assembly and the carrier using a sensor unit; a movement amount determination process of determining an alignment position of the electrode assembly based on relative position information of the electrode assembly relative to the carrier obtained in the sensing process; a pressing process of moving the electrode assembly from the carrier using a lifting unit in a first direction; and an alignment process of moving an alignment unit connected to the lifting unit supporting the electrode assembly based on the alignment position, while the electrode assembly is spaced apart from the carrier in the first direction.

In an embodiment, in the sensing process, the sensor unit may detect positions of a first edge of the electrode assembly, a second edge of the carrier, and an electrode tab connected to the electrode assembly.

In an embodiment, in the movement amount determination process, the processor may detect an expected movement amount of the electrode assembly, based on at least a portion of a difference in positions of the first edge and the second edge or a difference in positions of the electrode tab and the second edge.

In an embodiment, the carrier may include at least one recess. In the pressing process, the lifting unit may pass through the at least one recess to separate the electrode assembly from the carrier in a first direction.

In an embodiment, in the alignment process, while the electrode assembly is spaced apart from the carrier in the first direction, the alignment unit may move linearly in a second direction, perpendicular to the first direction or rotate around an axis disposed in the first direction.

In an embodiment, the electrode assembly alignment method may further include a lowering process of moving the at least one pressing unit in a third direction, opposite to the first direction.

### Advantageous Effects of Invention

According to an embodiment of the present disclosure, damage to an electrode assembly may be prevented.

According to an embodiment of the present disclosure, alignment accuracy of an electrode assembly may improved.

### BRIEF DESCRIPTION OF DRAWINGS

FIG. 1 is a perspective view of a battery cell according to an embodiment.

FIG. 2 is a schematic diagram of an electrode assembly alignment device according to an embodiment.

FIG. 3 is a schematic diagram of an electrode assembly alignment device according to an embodiment.

FIG. 4 is a perspective view of a carrier according to an embodiment.

FIG. 5 is a perspective view of a carrier according to another embodiment.

FIG. 6 is a schematic diagram of an electrode assembly alignment device according to an embodiment.

FIG. 7 is a flowchart of an electrode assembly alignment method according to an embodiment.

### BEST MODE FOR THE INVENTION

Hereinafter, the present disclosure will be described in detail with reference to the attached drawings. However, this is merely exemplary and the present disclosure is not limited to the specific embodiments exemplarily described.

The terms or words used in this specification and claims described below are not to be construed as limited to the usual or dictionary meanings. The inventor will interpret the terms or words in the sense and concept that are consistent with the technical idea of the present disclosure based on the principle that the inventor can appropriately define the concept of the term in order to explain the inventor's own invention in the best way.

Accordingly, it will be understood that the embodiments described in this specification and the configurations illustrated in the drawings are only the most preferred embodiments of the present disclosure and do not represent all of the technical ideas of the present disclosure, and that there may be various equivalents and modified examples that can replace the same at the time of this application.

Detailed descriptions of functions and configurations known in the art that may obscure the gist of the present disclosure will be omitted. In the attached drawings, some components are exaggerated, omitted, or schematically shown, and the size of each component does not entirely reflect the actual size.

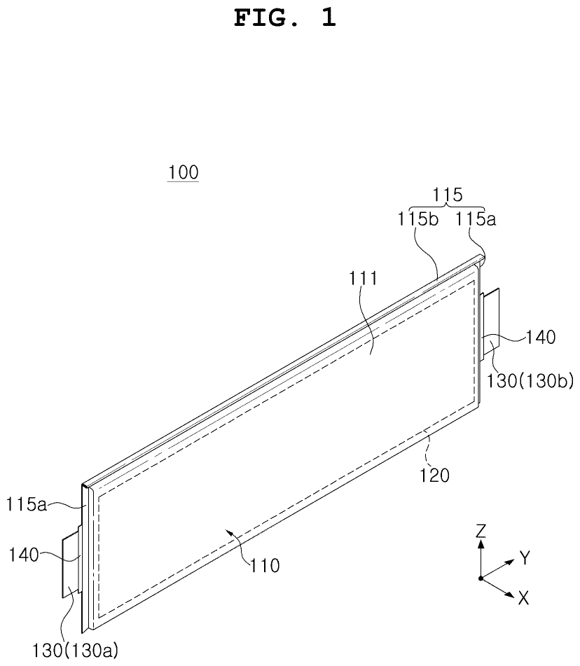

FIG. 1 is a perspective view of a battery cell according to an embodiment.

Referring to FIG. 1, a battery cell 100 may include a pouch 120, an electrode assembly 110, and an electrode tab 130. The battery cell 100 may be a secondary battery. For example, the battery cell 100 may be a lithium ion battery, but the present disclosure is not limited thereto. For example, the battery cell 100 may be a nickel-cadmium battery, a nickel-metal hydride battery, or a nickel-hydrogen battery that can be charged and discharged.

The pouch 120 may form at least a portion of the exterior of the battery cell 100. The pouch 120 may include an electrode receiving unit 111 receiving the electrode assembly 110 and a sealing unit 115 for sealing at least a portion of the periphery of the electrode receiving unit 111. The electrode receiving unit 111 may provide a space in which the electrode assembly 110 and an electrolyte are received.

The sealing unit 115 may be formed by bonding at least a portion of the periphery of the pouch 120. The sealing unit 115 may be formed in the form of a flange extending from the electrode receiving unit 111 formed in the form of a container externally, and may be disposed along at least a portion of the outer periphery of the electrode receiving unit 111. In an embodiment, the sealing unit 115 may include a first sealing unit 115a in which an electrode tab 130 is located and a second sealing unit 115b in which the electrode tab 130 is not located. A portion of the electrode tab 130 may be drawn out or exposed to the outside of the pouch 120. At a position at which the electrode tab 130 is drawn out, in order to increase a sealing degree of the first sealing unit 115a, and at the same time, to secure an electrical insulation state, the electrode tab 130 may be covered by an insulating film 140. The insulating film 140 may be formed of a film material thinner than that of the electrode tab 130, and may be attached to both surfaces of the electrode tab 130.

In an embodiment, an electrode tab 130 may be disposed on both sides of the battery cell 100 in a longitudinal direction (Y-axis direction), to face opposite directions. For example, the electrode tab 130 may include a cathode lead 130a of a first polarity (e.g., cathode) facing one side of the battery cell 100 in the longitudinal direction and an anode lead 130b of a second polarity (e.g., anode) facing the other side thereof in the longitudinal direction. In the embodiment illustrated in FIG. 1, the sealing unit 115 may include two first sealing units 115a in which an electrode tab 130 is disposed and one second sealing unit 115b in which an electrode tab 130 is not disposed. In an embodiment, the electrode tab 130 may be referred to as an electrode lead.

A direction in which the electrode tab 130 is located may be optionally designed. In an embodiment (e.g., FIG. 1), the electrode tab 130 may include a cathode lead 130a and an anode lead 130b located in the opposite direction of the cathode lead 130a with respect to the electrode assembly 110. In FIG. 1, an electrode tab 130 is disposed on both sides of the battery cell 100 in the longitudinal direction (e.g., Y-axis direction) to face opposite directions is illustrated, but a structure of the electrode tab 130 is not limited thereto. For example, two electrode tabs 130 may be disposed to be substantially parallel in the longitudinal direction (e.g., Y-axis direction) of the battery cell 100.

Meanwhile, the pouch 120 is not limited to a structure in which a single sheet of exterior material is folded to form a sealing unit 115 on three surfaces, as illustrated in FIG. 1.

In an embodiment of the present disclosure, at least a portion of the sealing unit 115 may be formed in a folded form at least once. By folding at least a portion of the sealing unit 115, bonding reliability of the sealing unit 115 may be improved, and an area of the sealing unit 115 may be minimized. According to an embodiment, a second sealing unit 115b of the sealing units 115 in which the electrode tab 130 is not disposed may be fixed by an adhesive member (not shown) after being folded twice. An angle at which the second sealing unit 115b is bent or the number of times the second sealing unit 115b is bent may be changed. For example, in an embodiment not shown, the second sealing unit 115b may be folded by 90° relative to the first sealing unit 115 a.

The electrode assembly 110 may include a cathode plate, an anode plate, and a separator. The separator may prevent contact between the cathode plate and the anode plate. Those skilled in the art will appreciate that the electrode assembly 110 may be manufactured using various methods. According to exemplary embodiments, an electrode assembly may be formed by repeatedly disposing a cathode, an anode, and a separator. In some embodiments, the electrode assembly may be of a winding type, a stacking type, a z-folding type, or a stack-folding type.

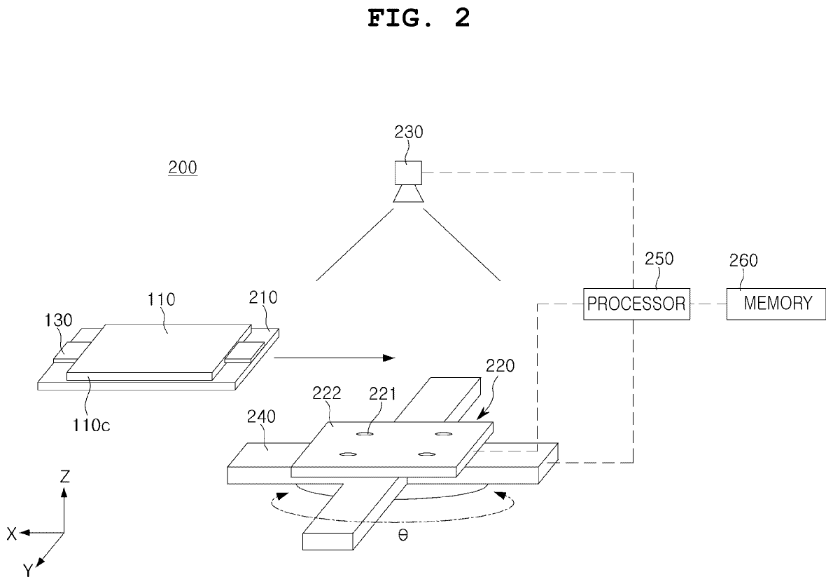

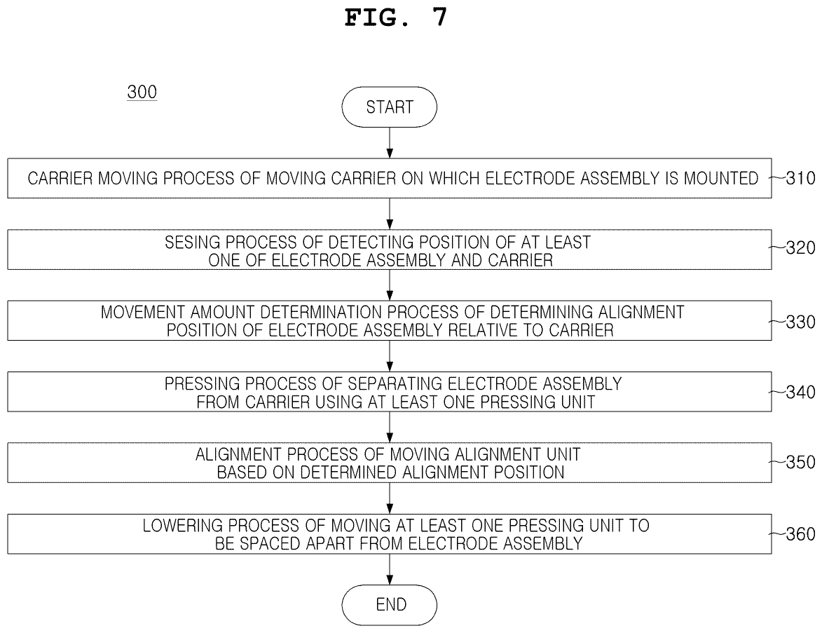

In FIG. 1, a pouch-type battery cell 100 is disclosed, but an electrode assembly alignment device (e.g., an electrode assembly alignment device 200 of FIG. 2) and an electrode assembly alignment method (e.g., an electrode assembly alignment method 300 of FIG. 7) of the present disclosure are not limited to the alignment of the electrode assembly 110 of the pouch-type battery cell 100. For example, the electrode assembly 110 of the present disclosure may be applied to a pouch-type battery cell, a prismatic battery cell, or a cylindrical battery cell.

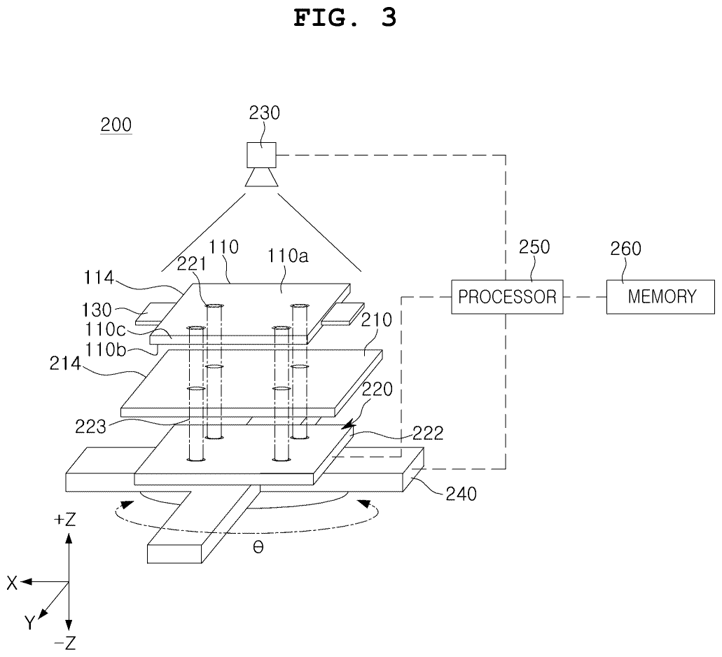

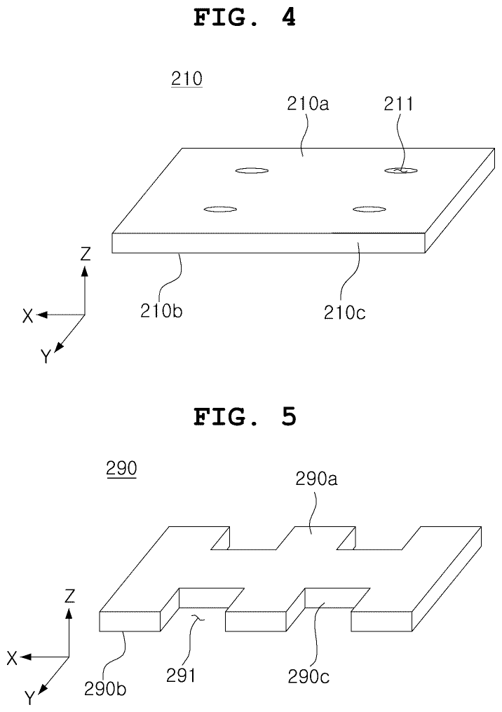

FIG. 2 is a schematic diagram of an electrode assembly alignment device according to an embodiment. FIG. 3 is a schematic diagram of an electrode assembly alignment device according to an embodiment. FIG. 4 is a perspective view of a carrier according to an embodiment.

Referring to FIGS. 2, 3, and/or 4, an electrode assembly alignment device 200 may include a carrier 210, a lifting unit 220, a sensor unit 230, an alignment unit 240, a processor 250, and/or a memory 260.

The electrode assembly alignment device 200 may change the position of the electrode assembly 110. For example, the electrode assembly alignment device 200 may change the position and/or posture of the electrode assembly 110 so that the electrode assembly 110 is present at a designated position.

In an embodiment, the electrode assembly 110 may include an upper surface 110a, a rear surface 110b opposite to the upper surface 110a and facing the carrier 210, and a side surface 110c surrounding at least a portion between the upper surface 110a and the rear surface 110b. The electrode assembly alignment device 200 may change the position and/or posture of the electrode assembly 110 without contacting the side surface 110c of the electrode assembly 110. For example, the electrode assembly alignment device 200 may be in contact with the rear surface 110b of the electrode assembly 110, and may not be in contact with the side surface 110c. Since the electrode assembly alignment device 200 does not contact the side surface 110c of the electrode assembly 110, damage to the electrode assembly 110 may be prevented. For example, the electrode assembly 110 may include at least one cathode plate, at least one anode plate, and at least one separator. At least a portion of at least one cathode plate, at least anode plate, and at least one separator may be exposed to the outside of the electrode assembly 110 on the side surface 110c of the electrode assembly 110. The electrode assembly alignment device 200 may not contact the side surface 110c of the electrode assembly 110, so that damage (e.g., short circuit) to the electrode assembly 110 may be prevented. In an embodiment, the electrode assembly alignment device 200 may be referred to as a non-contact alignment device.

The carrier 210 may support the electrode assembly 110. In an embodiment, the carrier 210 may have a substantially plate shape. For example, the carrier 210 may include a first surface 210a for supporting the electrode assembly 110, a second surface 210b opposite to the first surface 210a, and a third surface 210c surrounding at least a portion of a space between the first surface 210a and the second surface 210b. The electrode assembly 110 may be moved together with the carrier 210, while the electrode assembly 110 is disposed on the first surface 210a of the carrier 210. For example, the carrier 210 may be moved using a separate transport device while supporting the rear surface 110b of the electrode assembly 110. In an embodiment, the carrier 210 may be moved in a second direction (e.g., X-axis direction or Y-axis direction) perpendicular to the first direction (+Z direction) using a transport device (e.g., linear motion system (LMS)), which is not shown. The carrier 210 may be moved in the second direction to be located above the lifting unit 220 and the alignment unit 240.

The carrier 210 may include at least one recess 211 providing a path through which the lifting unit 220 passes. The recess 211 may be a through-hole penetrating through the first surface 210a and the second surface 210b of the carrier 210. The recess 211 may have a size that can be moved while at least a portion of the lifting unit 220 (e.g., pressing unit 221 and/or cylinder 223) is received within the recess 211. For example, a size of a first plane (e.g., an XY plane) of the recess 211 may be larger than the size of the first plane of the pressing unit 221 and/or the cylinder 223.

The lifting unit 220 may separate the electrode assembly 110 from the carrier 210. For example, the lifting unit 220 may include a pressing unit 221 that can move the electrode assembly 110 in a first direction (+Z direction) toward the first surface 210a of the carrier 210, a cylinder 223 connected to the pressing unit 221, and a support plate 222 connected to the cylinder 223. In an embodiment, the pressing unit 221 may refer to a portion of a component disposed on one surface of the cylinder 223 or a cylinder 223 forming one surface of the cylinder 223. The pressing unit 221 may be located in the first direction (+Z direction) of the cylinder 223. The cylinder 223 may be located between the pressing unit 221 and the support plate 222.

The pressing unit 221 and/or the cylinder 223 may pass through a recess 211 of the carrier 210. After passing through the recess 211 of the carrier 210, the pressing unit 221 may be in contact with a rear surface 1100b of the electrode assembly 110. For example, the pressing unit 221 may move up and down using the cylinder 223. The pressing unit 221 may raise or lower the electrode assembly 110. In an embodiment, the pressing unit 221 may provide pressure and/or force to the rear surface 110b of the electrode assembly 110, and the electrode assembly 110 may be spaced apart from the first surface 210a of the carrier 210 based on the pressure and/or force received from the pressing unit 221. A length of the cylinder 223 may be changed. The cylinder 223 may be a pneumatic and/or hydraulic actuation device. In another embodiment, the cylinder 223 may be replaced with another device (e.g., a motor and/or gear) for implementing a reciprocating movement in the first direction. In an embodiment, the pressing unit 221 may be referred to as an electrode assembly pressing device, an electrode assembly pusher, or a jelly roll pusher.

The number of pressing units 221 and cylinders 223 may be designed optionally. For example, the electrode assembly alignment device 200 may include a plurality of pressing units 221 and a plurality of cylinders 223.

The support plate 222 may support the cylinder 223. In an embodiment, the support plate 222 may include components (e.g., valves, piping, and/or wires) for driving the cylinder 223. A distance between the pressing unit 221 and the support plate 222 may be changed based on the length of the cylinder 223 in the first direction (e.g., +Z direction).

The sensor unit 230 may detect a position of at least one of the electrode assembly 110 and the carrier 210. For example, the sensor unit 230 may include at least one of a vision camera (e.g., an alignment vision camera) and a distance sensor. In an embodiment, the sensor unit 230 may detect positions of a first edge 114 of the electrode assembly 110 and/or an electrode tab 130 connected to the electrode assembly 110. The first edge 114 of the electrode assembly 110 may be a portion of the electrode assembly 110 adjacent to the side surface 110c of the electrode assembly 110. The sensor unit 230 may detect a position of a second edge 214 of the carrier 210.

The alignment unit 240 may change a relative position of the electrode assembly 110 relative to the carrier 210. For example, the alignment unit 240 may be moved while the electrode assembly 110 is spaced apart from the carrier 210 in the first direction (+Z direction). The alignment unit 240 may be connected to a lifting unit. The alignment unit 240 may move relatively to the carrier 210 together with the electrode assembly 110 and the lifting unit 220. Due to the movement of the alignment unit 240, the relative position of the electrode assembly 110 relative to the carrier 210 may be changed. For example, the alignment unit 240 may move linearly in a second direction (e.g., X-axis direction or Y-axis direction) perpendicular to the first direction (e.g., +Z direction). The alignment unit 240 may rotate around an axis disposed in the first direction (e.g., +Z direction). For example, the alignment unit 240 may rotate around an axis in the first direction (+Z direction) in which the lifting unit 220 reciprocates by a specified angle (θ). The alignment unit 240 may move based on the position of the electrode assembly 110 detected by the sensor unit 230. By moving the alignment unit 240, the position of the electrode assembly 110 may be finely adjusted. In an embodiment, the alignment unit 240 may be referred to as a moving unit, a moving portion, or a moving stage.

The processor 250 may drive the alignment unit 240 based on the information detected by the sensor unit 230. For example, the processor 250 may determine an expected movement amount of the electrode assembly 110 relative to the carrier 210, based on the positions of the electrode assembly 110 and the carrier 210 detected by the sensor unit 230. The expected movement amount may be a relative positional change amount of the electrode assembly 110 relative to the carrier 210. The expected movement amount may be referred to as an alignment position. The processor 250 may generate a signal for linearly moving or rotating the alignment unit 240, based on the position information of the electrode assembly 110 and the carrier 210 detected by the sensor unit 230. For example, the processor 250 may adjust the position of the alignment unit 240 by comparing the position of the electrode assembly 110 with the position of the carrier 210, detected by the sensor unit 230. In an embodiment, the processor 250 may compare a difference in positions of a first edge 114 of the electrode assembly 110 and a second edge 214 of the carrier 210 and/or a difference in positions of an electrode tab 130 connected to the electrode assembly 110 and a second edge 214 of a carrier 210.

The memory 260 may store reference position information of the electrode assembly 110. The reference position information may be information corresponding to a fixed position range of the electrode assembly 110. For example, the reference position information may be a value reflecting the difference in the positions of the first edge 114 of the electrode assembly 110 and/or the electrode tab 130 connected to the electrode assembly 110 and the second edge 214 of the carrier 210.

The processor 250 may generate a signal for linearly moving or rotating the alignment unit 240, based on a difference between the reference position information stored in the memory 260 and the positions of the electrode assembly 110 and the carrier 210 detected by the sensor unit 230. For example, the processor 250 may move the alignment unit 240 so that a difference in a distance between the first edge 114 of the electrode assembly 110 and the second edge 214 of the carrier 210 and a distance between the first edge 114 of the electrode assembly 110 and the second edge 214 of the carrier 210 stored in the memory 260 and/or a difference in a distance between the electrode tab 130 connected to the electrode assembly 110 and the second edge 214 of the carrier 210 and a distance between the electrode tab 130 connected to the electrode assembly 110 and the second edge 214 of the carrier 210 stored in the memory 260 may be within a specified value.

In an embodiment, the electrode assembly 110 may be aligned using the electrode assembly alignment device 200, so that, when the electrode tab 130 and an electrode lead (e.g., a current collector connected to the electrode assembly 110) (not shown) are welded, welding precision may be improved.

In an embodiment, the electrode assembly 110 may be aligned using the electrode assembly alignment device 200, so that, when a pouch (e.g., the pouch 120 of FIG. 1) having the electrode assembly 110 received therein sealed, sealing precision can be improved.

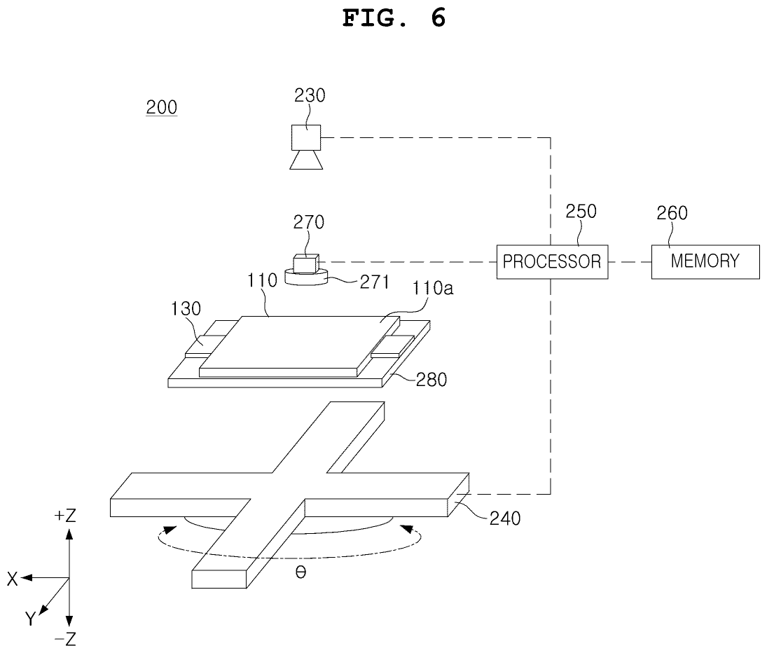

FIG. 5 is a perspective view of a carrier according to another embodiment.

Referring to FIG. 5, a carrier 290 may include at least one recess 291. At least some of the description of the carrier 210 of FIGS. 2, 3, and/or 4 may be applied to that of the carrier 290 of FIG. 5.

In an embodiment, the carrier 290 may have a plate shape with a groove formed therein. For example, the carrier 290 may include a first surface 290a for supporting an electrode assembly (e.g., electrode assembly 110 of FIG. 3), a second surface 290b opposite the first surface 290a, and a third surface 290c surrounding at least a portion of a space between the first surface 290a and the second surface 290b.

The carrier 290 may include at least one recess 291 providing a path through which a lifting unit (e.g., the lifting unit 220 of FIG. 3) passes. The recess 291 may be a slit or groove formed on the third surface 290c of the carrier 290. The recess 291 may be an empty space formed on the first surface 290a, the second surface 290b, and the third surface 290c of the carrier 290. The lifting unit 220 may be moved from one side of the carrier 290 (e.g., a portion facing the second surface 290b) to the other side of the carrier 290 (e.g., a portion facing the first surface 290a) through the recess 291.

A shape of the carriers 210 and 290 illustrated in the present disclosure is exemplary. For example, if the carriers 210 and 290 allow contact of the lifting unit 220 with the electrode assembly 110, the number and/or position of the recesses 211 and 291 formed in the carriers 210 and 290 are not limited.

FIG. 6 is a schematic diagram of an electrode assembly alignment device according to an embodiment.

Referring to FIG. 6, an electrode assembly alignment device 200 may include a carrier 280, a gripper 270, a sensor unit 230, an alignment unit 240, a processor 250, and/or a memory 260.

At least some of the descriptions of the electrode assembly alignment device 200 of FIG. 2, FIG. 3, and/or FIG. 4 with respect to the carrier 210, the sensor unit 230, the alignment unit 240, the processor 250, and/or the memory 260 may be applied to those of the electrode assembly alignment device 200 of FIG. 6 with respect to the carrier 280, the sensor unit 230, the alignment unit 240, the processor 250, and/or the memory 260.

A gripper 270 may separate the electrode assembly 110 from a carrier 280. For example, the gripper 270 may include a suction pad 271, and the suction pad 271 may move downwardly (e.g., in a −Z direction) to contact an upper surface 110a of the electrode assembly 110. After the suction pad 271 is attached to the electrode assembly 110, the gripper 270 may move in a first direction (e.g., in a +Z direction) together with the electrode assembly 110, and the electrode assembly 110 may be spaced apart from the carrier 280.

The alignment unit 240 may change a relative position of the electrode assembly 110 relative to the carrier 280. For example, the alignment unit 240 may move while the electrode assembly 110 is spaced apart from the carrier 280 in the first direction (in +Z direction). In an embodiment, the alignment unit 240 may be connected to the carrier 280. The alignment unit 240 may move relatively to the electrode assembly 110 together with the carrier 280. In another embodiment, the alignment unit 240 may be connected to a gripper 270. The alignment unit 240 may move relatively to the carrier 280 together with the gripper 270 and the electrode assembly 110.

Due to the movement f the alignment unit 240, the relative position of the electrode assembly 110 to the carrier 280 may be changed. For example, the alignment unit 240 may move linearly in a second direction (e.g., X-axis direction or Y-axis direction), perpendicular to the first direction (e.g., +Z direction). The alignment unit 240 may rotate around an axis disposed in a first direction (e.g., +Z direction). For example, the alignment unit 240 may rotate around an axis disposed in a first direction (+Z direction) in which the gripper 270 reciprocates by a specified angle (θ). The gripper 270 may move based on the position of the electrode assembly 110 detected by the sensor unit 230.

By omitting the lifting unit (e.g., the lifting unit 220 of FIG. 3), the carrier 280 of FIG. 6 may not include a recess for providing a path through which the lifting unit 220 passes.

FIG. 7 is a flowchart of an electrode assembly alignment method according to an embodiment.

Referring to FIG. 7 together with FIG. 2 and FIG. 3, an electrode assembly alignment method 300 may include a carrier moving process 310 of moving a carrier 210 on which an electrode assembly 110 is mounted, a sensing process 320 of detecting positions of the electrode assembly 110 and the carrier 210 using a sensor unit 230, a movement amount determination process 330 of determining an alignment position of the electrode assembly 110 relative to the carrier 210, a pressing process 340 of separating the electrode assembly 110 from the carrier 210 using at least one pressing unit 221, and an alignment process 350 of moving an alignment unit 240 while the electrode assembly 110 is spaced apart from the carrier 210.

The electrode assembly alignment method 300 of FIG. 7 may be a method for manufacturing the electrode assembly 100 of FIG. 1. For example, the electrode assembly alignment method 300 of FIG. 7 may be performed by the electrode assembly alignment device 200 of FIG. 2 and FIG. 3.

The carrier moving process 310 of moving the carrier 210 on which the electrode assembly 110 is mounted may move the carrier 210 so that the carrier 210 is located above the lifting unit 220. During the carrier moving process 310, the electrode assembly 110 may move together with the carrier 210, while the electrode assembly 110 is mounted on the carrier 210. The carrier moving process 310 may move the carrier 210 and the electrode assembly 110 to a designated position so that at least one pressing unit 221 of the lifting unit 220 corresponds to the recess 211 of the carrier 210. In an embodiment, the carrier moving process 310 may be performed by moving the carrier 210 using an unillustrated transport device (e.g., a linear motion system (LMS)). By the carrier moving process 310, the electrode assembly 110 and the carrier 210 may be moved to a position detected by a sensor unit 230.

In a sensing process 320 of detecting a position of at least one of the electrode assembly 110 and the carrier 210 using the sensor unit 230, the sensor unit 230 may detect a specific point of the electrode assembly 110 (e.g., a first edge 114) and/or a position of the electrode tab 130 connected to the electrode assembly 110. The sensor unit 230 may detect a position of a specific point (e.g., a second edge 214) of the carrier 210. In an embodiment, the sensing process 320 may be performed before the pressing process 330.

In the movement amount determination process 330 for determining an alignment position of the electrode assembly 110 relative to the carrier 210, the processor 250 may determine an alignment position of the electrode assembly 110, based on relative position information of the electrode assembly 110 relative to the carrier 210, detected by the sensor unit 230. The alignment position of the electrode assembly 100 may be an expected movement amount by which the electrode assembly 110 should be moved relatively to the carrier 210. In an embodiment, the movement amount determination process 330 may be performed after the sensing process 320 and before the pressing process 340. In another embodiment not shown, the movement amount determination process 330 may be performed after the pressing process 340 and before the alignment process 350.

In the movement amount determination process 330, the expected movement amount by which the electrode assembly 110 should be moved relatively to the carrier 210 may be determined based on positions of a first edge 114, a second edge 214, and/or an electrode tab 130 detected in the sensing process 320. For example, the movement amount determination process 330 may determine the expected movement amount of the electrode assembly 110 based on at least a portion of a difference in the positions of the first edge 114 and the second edge 214 or a difference in the positions of the electrode tab 130 and the second edge 214 using a processor 250. In an embodiment, the movement amount determination process 330 may determine the expected movement amount by which the electrode assembly 110 should be moved relatively to the carrier 210 based on reference position information stored in a memory (e.g., memory 260 of FIG. 3) and the positions of the first edge 114, the second edge 214, and/or the electrode tab 130 detected in the sensing process 330. Reference position information may be information corresponding to a fixed position range of the electrode assembly 110. For example, the reference position information may be a value reflecting the difference in the positions of the first edge 114 of the electrode assembly 110 and/or the electrode tab 130 connected to the electrode assembly 110 and the second edge 214 of the carrier 210. In an embodiment, the movement amount determination process 330 may determine a difference between a distance between the first edge 114 of the electrode assembly 110 and the second edge 214 of the carrier 210 and a distance between the first edge 114 of the electrode assembly 110 and the second edge 214 of the carrier 210 stored in the memory 260. In one embodiment, the movement amount determination process 330 may determine the difference in the distance between an electrode tab 130 connected to the electrode assembly 110 and a second edge 214 of the carrier 210 and the distance between the electrode tab 130 connected to the electrode assembly 110 and the second edge 214 of the carrier 210 stored in the memory 260.

A pressing process 340 separating the electrode assembly 110 from the carrier 210 using at least one pressing unit 221 may separate the electrode assembly 110 from the carrier 210 in a first direction (e.g., +Z direction). For example, the pressing process 340 may cause at least one pressing unit 221 to pass through a recess 211 of the carrier 210 to separate the electrode assembly 110 in a first direction (+Z direction) relative to the carrier 210.

The alignment process 350 of moving the alignment unit 240 while the electrode assembly 110 is spaced apart from the carrier 210 may be performed while the electrode assembly 110 is spaced apart from the carrier 210 in the first direction (+Z direction). The alignment process 350 may move the alignment unit 240 linearly in a second direction (e.g., X-axis direction or Y-axis direction), perpendicular to the first direction (+Z direction) or rotate around an axis disposed in the first direction (+Z direction). The alignment unit 240 may be connected to at least one pressing unit 221. The alignment unit 240 may be moved together with the electrode assembly 110 in contact with at least one pressing unit 221. For example, the electrode assembly 110 may move relative to the carrier 210 based on a linear movement and/or a rotational movement of the alignment unit 240. In the alignment process 350, the alignment unit 240 may be moved based on the alignment position determined in the movement amount determination process 330.

The electrode assembly alignment method 300 may further include a lowering process 360 in which at least one pressing unit 221 is moved to be spaced apart from the electrode assembly 110. In the lowering process 360, at least one pressing unit 221 may be moved in a third direction (−Z direction), opposite to the first direction (+Z direction). At least one prepressing unit 221 may be moved downwardly (e.g., in the third direction (−Z direction)) of the carrier 210 through the recess 211 by the lowering process 360. After the lowering process 360, the electrode assembly 110 may be positioned upwardly of the carrier 210 (e.g., in the first direction (+Z direction)) and may be moved together with the carrier 210 to a position not facing the lifting unit 220.

In an embodiment (e.g., FIG. 6), the prepressing process 340 may be replaced with a rising process of the electrode assembly 110 using a gripper 270. For example, the electrode assembly alignment device 200 may not include a lifting unit 220, and may separate the electrode assembly 110 from a carrier 280 using the gripper 270. In an embodiment, the processor 250 may move the alignment unit 240 connected to the carrier 280 based on the determined alignment position to adjust a position of the electrode assembly 110 relative to the carrier 280. In an embodiment, the processor 250 may move a gripper 270 holding the electrode assembly 110 based on the determined alignment position to adjust the position of the electrode assembly 110 relative to the carrier 280. In an electrode assembly alignment method 300 including a rising process of the electrode assembly 110 using a gripper 270, a lowering process 360 may be replaced with a lowering process of a gripper 270 holding the electrode assembly 110.

The contents described above is merely an example of applying the principles of the present disclosure, and other configurations may be further included without departing from the scope of the present disclosure.

While example embodiments have been shown and described above, the scope of the present disclosure is not limited thereto, and it will be apparent to those skilled in the art that modifications and variations could be made without departing from the scope of the present disclosure as defined by the appended claims. For example, the present disclosure may be implemented by deleting some of the components in the above-described embodiments, and the respective embodiments may be implemented in combination with each other.

1. An electrode assembly alignment device, comprising:
a carrier configured to support an electrode assembly;
a lifting unit including at least one pressing unit configured to separate the electrode assembly from the carrier;
a sensor unit configured to detect a position of the electrode assembly; and
an alignment unit connected to the lifting unit, and configured to move based on the position of the electrode assembly detected by the sensor unit,
wherein the alignment unit is configured to move relatively to the carrier together with the at least one pressing unit supporting the electrode assembly while the electrode assembly is spaced apart from the carrier.

2. The electrode assembly alignment device of claim 1, wherein the lifting unit includes a cylinder connected to the at least one pressing unit and a support plate connected to the cylinder, and
the cylinder is configured to move in a first direction from the support plate toward the carrier.

3. The electrode assembly alignment device of claim 2, wherein the alignment unit is configured to move linearly in a second direction, perpendicular to the first direction, together with the support plate, or rotate around an axis disposed in the first direction.

4. The electrode assembly alignment device of claim 1, wherein the carrier includes at least one recess providing a path through which the lifting unit passes.

5. The electrode assembly alignment device of claim 4, wherein a cross-sectional area of the at least one recess is greater than a cross-sectional area of the at least one pressing unit.

6. The electrode assembly alignment device of claim 1, further comprising:
a processor configured to determine a position of the electrode assembly, based on the position information detected by the sensor unit, and generate a signal for linearly moving or rotating the alignment unit.

7. The electrode assembly alignment device of claim 6, further comprising:
a memory configured to store reference position information of the electrode assembly,
wherein the processor is configured to generate a signal for linearly moving or rotating the alignment unit based on a difference between the reference position information and the positions of the electrode assembly and the carrier detected by the sensor unit.

8. The electrode assembly alignment device of claim 1, wherein the sensor unit includes at least one of a vision camera or a distance sensor configured to detect a position of an edge of the electrode assembly or a position of an electrode tab connected to the electrode assembly.

9. The electrode assembly alignment device of claim 1, wherein the electrode assembly includes an upper surface, a rear surface, opposite to the upper surface, and a side surface surrounding at least a portion between the upper surface and the rear surface, and
the at least one pressing unit is configured to contact the upper surface or the rear surface.

10. An electrode assembly alignment method, comprising:
a carrier moving process of moving a carrier on which an electrode assembly is mounted;
a sensing process of detecting a position of at least one of the electrode assembly and the carrier using a sensor unit;
a movement amount determination process of determining an alignment position of the electrode assembly based on relative position information of the electrode assembly relative to the carrier obtained in the sensing process;
a pressing process of moving the electrode assembly in a first direction relative to the carrier using a lifting unit; and
an alignment process of moving the lifting unit supporting the electrode assembly based on the alignment position, while the electrode assembly is spaced apart from the carrier in the first direction.

11. The electrode assembly alignment method of claim 10, wherein in the sensing process, the sensor unit detects positions of a first edge of the electrode assembly, a second edge of the carrier, and an electrode tab connected to the electrode assembly.

12. The electrode assembly alignment method of claim 11, wherein in n the movement amount determination process, the processor determines an expected movement amount of the electrode assembly, based on at least a portion of a difference in the positions of the first edge and the second edge or a difference in the positions of the electrode tab and the second edge.

13. The electrode assembly alignment method of claim 10, wherein the carrier includes at least one recess, and
in the pressing process, the lifting unit passes through the at least one recess, to separate the electrode assembly from the carrier in a first direction.

14. The electrode assembly alignment method of claim 13, wherein in the alignment process, while the electrode assembly is spaced apart from the carrier in the first direction, the alignment unit moves linearly in a second direction, perpendicular to the first direction, or rotates around an axis disposed in the first direction.

15. The electrode assembly alignment method of claim 13, further comprising:
a lowering process of moving the at least one pressing unit in a third direction, opposite to the first direction.
